(19) United States
(12) Patent Application Publication
(10) Pub. No.: US 2013/0063351 A1
(43) Pub. Date: Mar. 14, 2013

(54) MOUSE

(71) Applicants: Raghuram Reddy Talasani, San Antonio, TX (US); Stephen James Cook, Seattle, WA (US)

(72) Inventors: Raghuram Reddy Talasani, San Antonio, TX (US); Stephen James Cook, Seattle, WA (US)

(21) Appl. No.: 13/232,228

(22) Filed: Sep. 14, 2011

(51) Int. Cl. G09G 5/08

(52) U.S. Cl. 345/163

(57) ABSTRACT

A computer mouse designed to reduce the symptoms of and/or prevent Carpel Tunnel Syndrome.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

Carpal Tunnel Syndrome (CTS) is pressure on the median nerve. The carpal tunnel is a compartment which is located at the base of the wrist. Multiple flexor tendons and the median nerve pass through the carpal tunnel. The nerve and tendons provides feelings and movement to the thumb side of the hand; i.e. the palm, thumb, index finger, middle finger, and thumb side of the ring finger. Because the carpal tunnel area is normally narrow, any swelling can pinch the nerve and cause pain, numbness, tingling and/or weakness. CTS is common in people who perform repetitive motions of the hand and wrist. Operating a computer mouse (or “mouse”) is a common cause of CTS.

### BRIEF DESCRIPTION OF INVENTION

The computer mouse described herein is designed to reduce the symptoms of and/or prevent CTS. FIG. 1 show a computer mouse 10 known in the art. The known mouse 10 has a substantially integral upper surface 20 and a length 30. Referring to FIGS. 2a and 2b, to pick up a computer mouse, the user must place his palm over the mouse placing the thumb on one side of the mouse and the pinky, and sometimes the ring finger, on the other side of the mouse. The thumb and pinky are moved toward the other in order to secure the mouse in the user's hand. The hand and the wrist are used to lift or move the mouse. This repetitive movement is known to cause and/or exaggerate CTS. An object of this invention is to provide a means to lift the mouse without requiring the user to move the pinky and thumb together.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a perspective view of a prior art computer mouse;

FIG. 2a is a perspective view of a hand positioning over a prior art computer mouse;

FIG. 2b is a perspective view of a hand grasping a prior art computer mouse;

FIG. 3 is a perspective view of a hand grasping one embodiment of the computer mouse described herein;

FIG. 4 is a front perspective view of one embodiment of the computer mouse described herein;

FIG. 5 is a side perspective view of a wing;

FIG. 6 is a side perspective view of the slots on the computer mouse which accepts a ladder or wing;

FIG. 7 is a side perspective view of a ladder

FIG. 8 is a front perspective view of second embodiment of the computer mouse described herein.

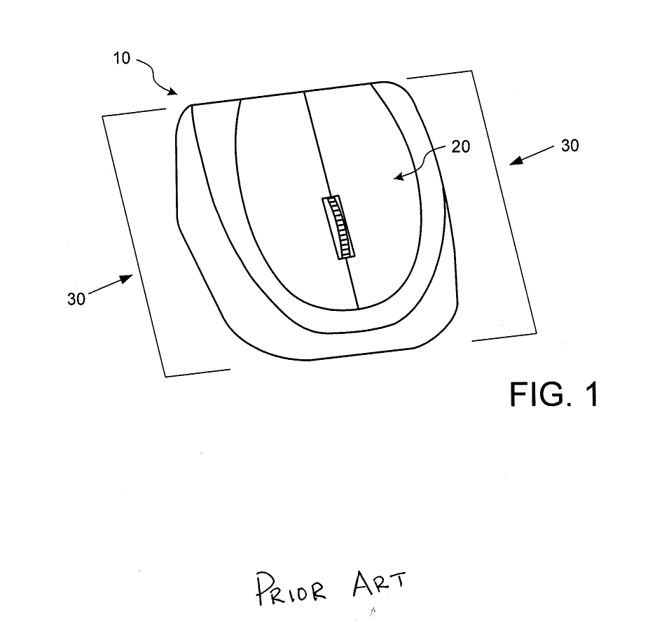

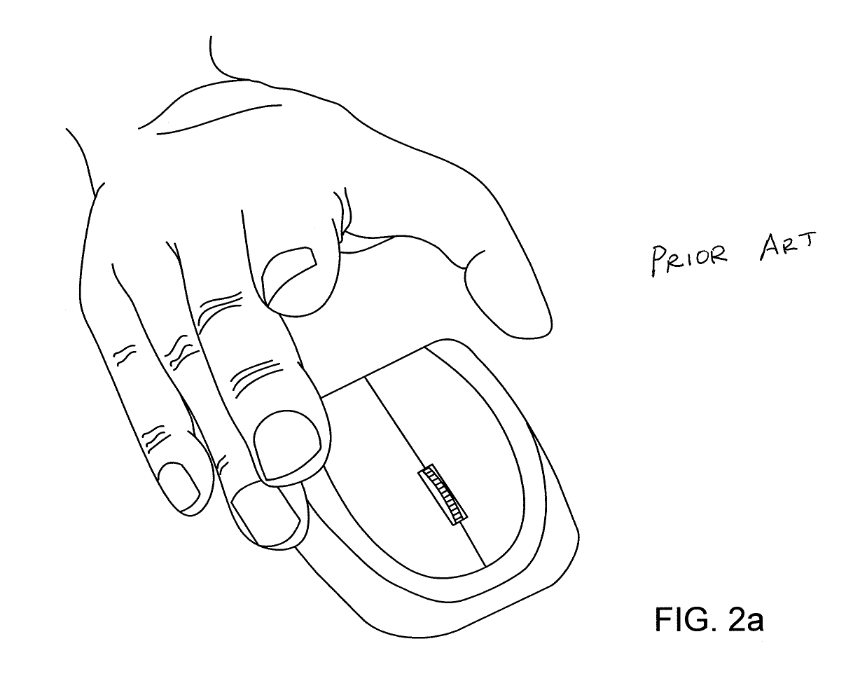

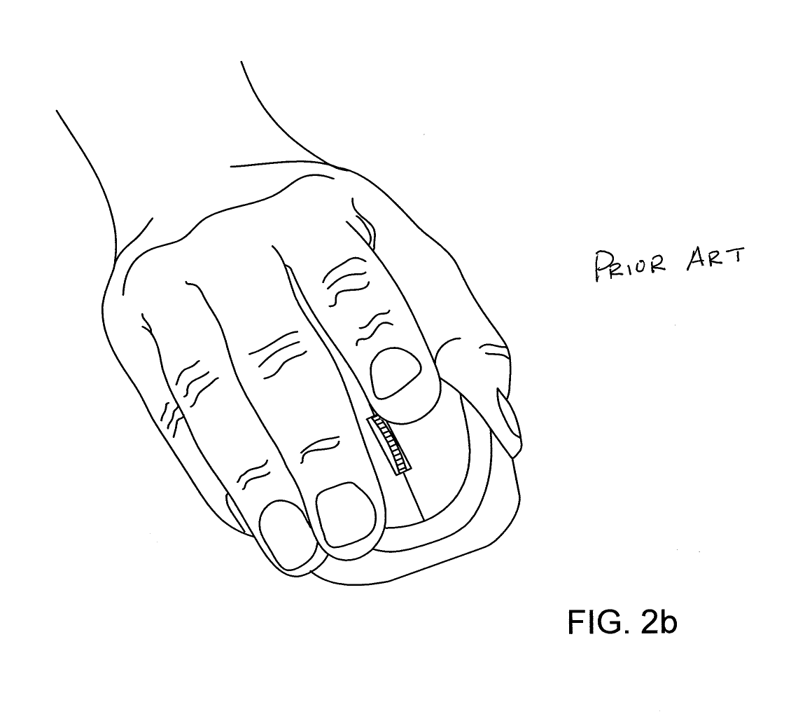

### DETAILED DESCRIPTION OF THE INVENTION

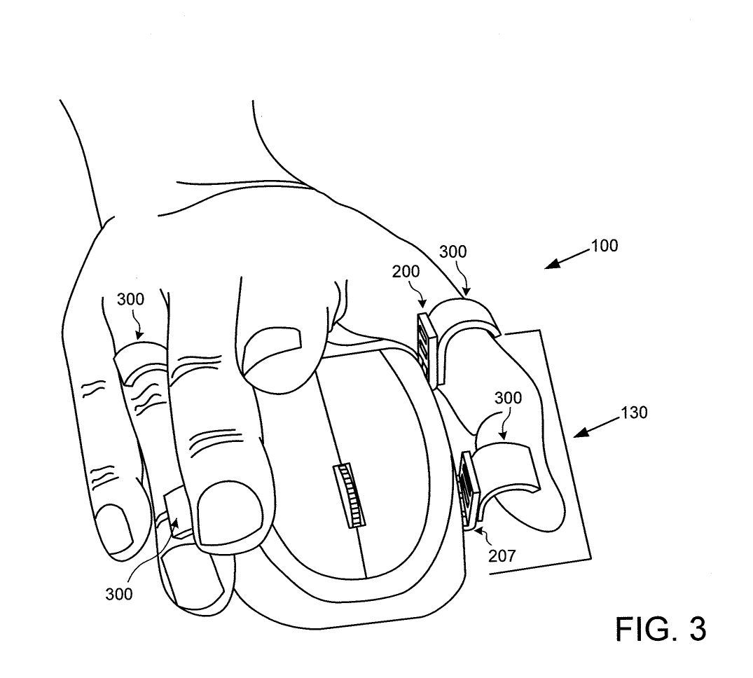

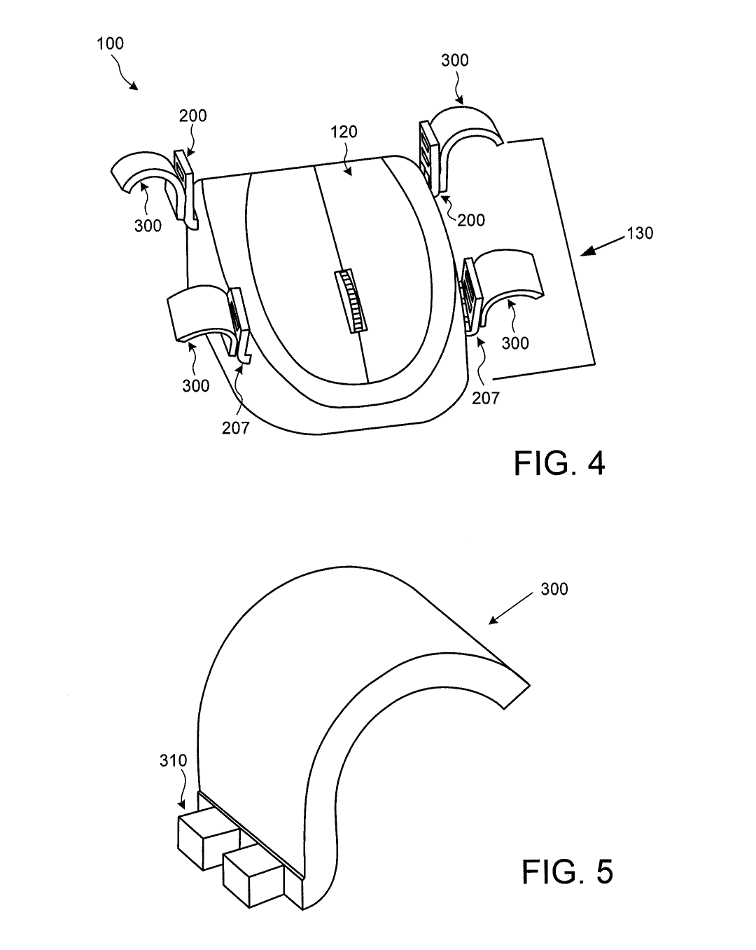

The purpose of the inventions described herein is to provide a new and improved means to lift and handle a computer mouse so as to prevent and/or reduce the symptoms of CTS. FIG. 3 shows an embodiment of a computer mouse 100. Referring to FIGS. 4-7, in this embodiment, the mouse has a substantially integral upper surface 120 and a length 130. The length 130 of the mouse 100 is comprised of a plurality of ladders 200. Each ladder 200 defines a plurality of slots 210. Each slot 210 accepts a wing 300. The wing 300 is substantially curved. The curve has a radius sufficient to accommodate an adult human finger.

Referring to FIG. 5, in a preferred embodiment, the wing 300 comprises at least one male extension 310. The slots 210 of ladder 200 accept the male extension 310. The wing 300 can be inserted into any one of the plurality of slots 210 on a single ladder 200 to accommodate the hand size of a user.

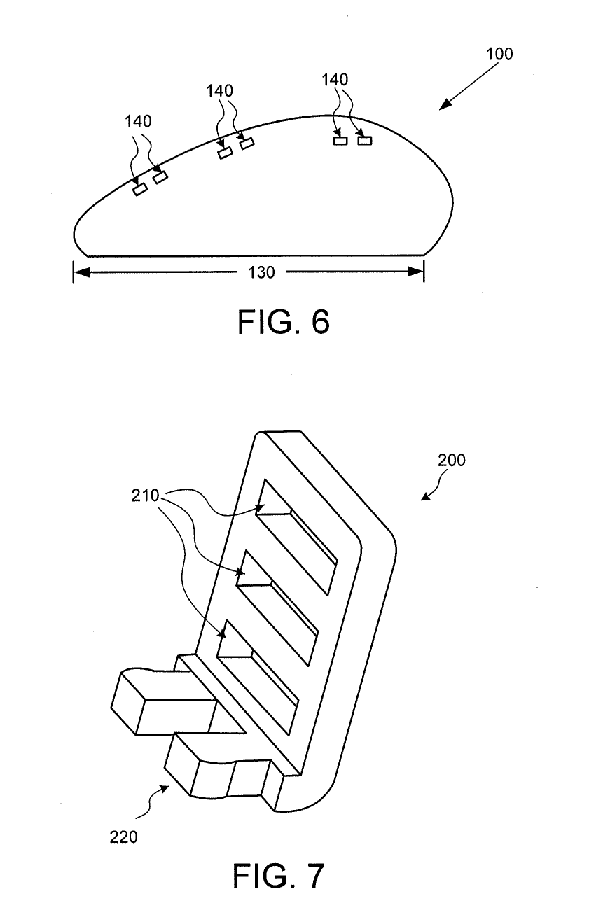

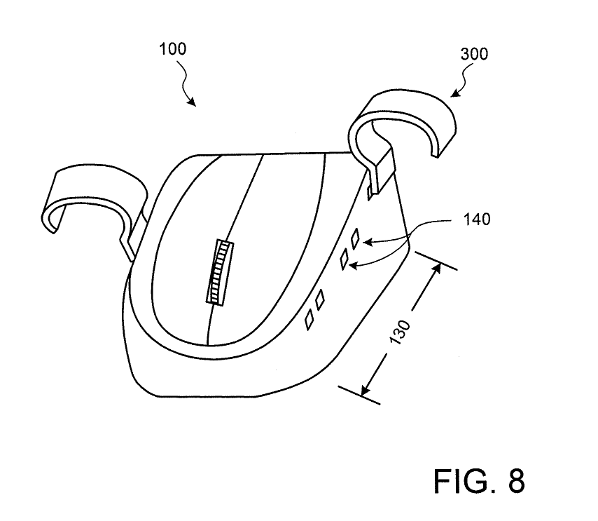

Referring to FIG. 6, in another preferred embodiment, the mouse 100 defines a plurality of slots (mouse slots) 140 along the length 130. Referring to FIG. 7, in a preferred embodiment, the ladder 200 comprises a male extension (ladder extension) 220. Each mouse slot 140 accepts a ladder extension 220. And, as described above, each ladder accepts a wing 330. In this embodiment, the number of ladders 220 and the location of the ladders 200 along the length 130 are chosen by the user to accommodate his comfort level. Referring to FIG. 8, in another preferred embodiment, the mouse 100 defines a plurality of slots (mouse slots) 140 along the length 130. Each mouse slot 140 accepts a wing 300. It should be noted that a person having ordinary skill in the art may vary the means used to attach the ladder 200 to the mouse and the wing 300 to the ladder 200.

What is claimed is:

1. A computer mouse assembly for alleviating and/or preventing the symptoms of Carpel Tunnel Syndrome comprising:
a computer mouse having a substantially integral upper surface and length;
at least one ladder is attached to the length of the computer mouse;
at least one wing.

2. The computer mouse assembly of claim 1 where the at least one ladder defines at least one slot.

3. The computer mouse assembly of claim 1 where the at least one wing is substantially curved.

4. The computer mouse assembly of claim 2 where the at least one wing comprises at least one male extension.

5. The computer mouse assembly of claim 2 where the at least one slot of claim 2 accepts the at least one male extension of claim 4.

6. A computer mouse assembly for alleviating and/or preventing the symptoms of Carpel Tunnel Syndrome comprising:
a computer mouse having a substantially integral upper surface and length;
the length defining a plurality of slot (mouse slots);
at least one ladder;
at least one wing.

7. The computer mouse assembly of claim 6 where the ladder defines a plurality of slots and comprises at least one male extension (ladder extension).

8. The computer mouse assembly of claim 6 where the wing is substantial curved and comprises at least one male extension (wing extension).

9. The computer mouse assembly of claim 6 where the mouse slots accepts the ladder extensions.

10. The computer mouse assembly of claim 6 where the ladder slots accepts the wing extension.

11. A computer mouse assembly for alleviating and/or preventing the symptoms of Carpel Tunnel Syndrome comprising:
a computer mouse having a substantially integral upper surface and length;
the length defining a plurality of slot (mouse slots);
at least one wing.

12. The computer mouse assembly of claim 11 where the mouse slots accepts the at least one wing.
